(19) United States
(12) Patent Application Publication
(10) Pub. No.: US 2024/0380061 A1
(43) Pub. Date: Nov. 14, 2024

(54) ELECTROCHEMICAL CELLS WITH VENTS, AND METHODS OF MANUFACTURING THE SAME

(71) Applicant: 24M Technologies, Inc., Cambridge, MA (US)

(72) Inventors: Jacob ZIMMERMAN, Waltham, MA (US); Ryan Michael LAWRENCE, Watertown, MA (US)

(21) Appl. No.: 18/655,863

(22) Filed: May 6, 2024

Related U.S. Application Data
(60) Provisional application No. 63/464,773, filed on May 8, 2023.

(51) Int. Cl. H01M 50/342; H01M 10/0525; H01M 10/0587; H01M 50/105; H01M 50/186; H01M 50/197; H01M 50/198

(52) U.S. Cl. CPC H01M 50/3425; H01M 10/0525; H01M 10/0587; H01M 50/105; H01M 50/186; H01M 50/197; H01M 50/198; H01M 2200/20

(57) ABSTRACT

Embodiments described herein relate to electrochemical devices and electrochemical cells with vents and venting mechanisms. In some aspects, an electrochemical device can include an anode disposed on an anode current collector, a cathode disposed on a cathode current collector, a separator disposed between the anode and the cathode, a first film disposed on the anode current collector and having outer edges extending beyond outer edges of the anode current collector, and a second film disposed on the cathode current collector and having outer edges extending beyond outer edges of the cathode current collector, the second film bonded to the first film along a sealing region to form a pouch, the pouch having an internal pressure, the sealing region including a first portion and a second portion, the second portion configured to fail at a lower internal pressure than the first portion.

### RELATED APPLICATIONS

This application claims priority to and benefit of U.S. Provisional Application No. 63/464,773, filed May 8, 2023 and titled “Electrochemical Cells with Vents and Methods of Manufacturing the Same,” the entire disclosure of which is hereby incorporated by reference herein.

### TECHNICAL FIELD

Embodiments described herein relate to electrochemical cells with vents and venting mechanisms.

### BACKGROUND

Pressure buildup in electrochemical cells can lead to thermal runaway, ruptures, and explosions of the electrochemical cells. These explosions can lead to shrapnel and dangerous debris. Damage from cell failures can be widespread and catastrophic. Several mechanisms have been developed for the release of pressure and improvement of safety in cells, but these mechanisms are typically only compatible with cells consisting of rigid casings, for example cylindrical or prismatic cells with solid steel or aluminum casings. There are no widely implemented solutions for cells using flexible laminate casings, common in many applications including electric vehicles.

### SUMMARY

Embodiments described herein relate to electrochemical devices and electrochemical cells with vents and venting mechanisms. In some aspects, an electrochemical device can include an anode disposed on an anode current collector, a cathode disposed on a cathode current collector, a separator disposed between the anode and the cathode, a first film disposed on the anode current collector and having outer edges extending beyond outer edges of the anode current collector, and a second film disposed on the cathode current collector and having outer edges extending beyond outer edges of the cathode current collector, the second film bonded to the first film along a sealing region to form a pouch, the pouch having an internal pressure, the sealing region including a first portion and a second portion, the second portion configured to fail at a lower internal pressure than the first portion.

In some aspects, a method includes: disposing an anode material onto an anode current collector; disposing a cathode material onto a cathode current collector; coupling the anode material to the cathode material with a separator material interposed between the anode material and the cathode material; coupling a first film to the anode current collector; coupling a second film to the cathode current collector; sealing an edge between the first film and the second film to form a pouch; and disposing a frame around the pouch to form an electrochemical cell, the frame including a puncture member configured to pierce the pouch in response to the pouch expanding to a larger than a threshold size.

### BRIEF DESCRIPTION OF THE DRAWINGS

Unless otherwise indicated, dotted lines indicate optional features or optional couplings.

FIG. 1 is a block diagram of an electrochemical cell, according to an embodiment.

FIG. 2 is a block diagram of an electrochemical cell, according to an embodiment.

FIG. 3 is an illustration of an electrochemical cell, according to an embodiment.

FIG. 4 is an illustration of an electrochemical cell, according to an embodiment.

FIGS. 5A-5C are illustrations of an electrode tab with a venting mechanism, according to an embodiment.

FIGS. 6A-6B are illustrations of an electrode tab with a venting mechanism, according to an embodiment.

FIGS. 7A-7F are illustrations of an electrochemical cell with a venting mechanism, according to an embodiment.

FIGS. 8A-8B are illustrations of an electrochemical cell with a piercing implement, according to an embodiment.

FIGS. 9A-9C are illustrations of a piercing implement, according to an embodiment.

FIGS. 10A-10D are illustrations of a piercing implement, according to an embodiment.

FIGS. 11A-11C are illustrations of an electrochemical cell with a piercing implement, according to an embodiment.

FIGS. 12A-12C are illustrations of an electrochemical cell with a piercing implement, according to an embodiment.

### DETAILED DESCRIPTION

Embodiments described herein relate to pressure relief in electrochemical cells. During thermal runaway, lithium-ion electrochemical cells generate large quantities of gas as the electrolyte boils and the active materials in the electrochemical cells decompose. Hard-cased prismatic and cylindrical cells can include vent features to control 1) vent pressure and 2) vent location. Without a controlled vent feature, several potential failure modes are created. For example, cells can explode due to overpressure, creating flying material and shrapnel.

Electrochemical cells can rupture and vent in unpredictable locations, which can cause damage to users or sensitive electronics. Additionally, high pressure expansion of electrochemical cells can damage restraining hardware (e.g., loss of containment, damage to adjacent structures). Due to their minimalist design, pouch cells are often built without an integrated vent feature. Therefore, they are susceptible to the aforementioned failure modes.

Embodiments described herein enable controlled venting in a lithium-ion pouch cell. In some aspects, the cells can include a pouch with a first portion and a second portion, the second portion configured to fail at a lower pressure than the first portion. In some embodiments, the second portion can be formed from pressing the second portion at a lower temperature, pressure, and/or for a decreased duration during pressing, compared to the first portion. In some embodiments, the second portion can be formed from a weaker sealing adhesive, compared to the first portion.

In some aspects, an electrochemical cell can include a piercing element. The piercing element can be fixed to the interior or exterior surface of the pouch. In some embodiments, the piercing element can be fixed to a frame. In some embodiments, electrochemical cells described herein can include ventilation implements described in U.S. Patent Publication No. U.S. 2018/0233722 (“the '722 publication”), titled, “Systems and Methods for Improving Safety Features in Electrochemical Cells,” filed Feb. 1, 2018, the disclosure of which is hereby incorporated by reference in its entirety.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

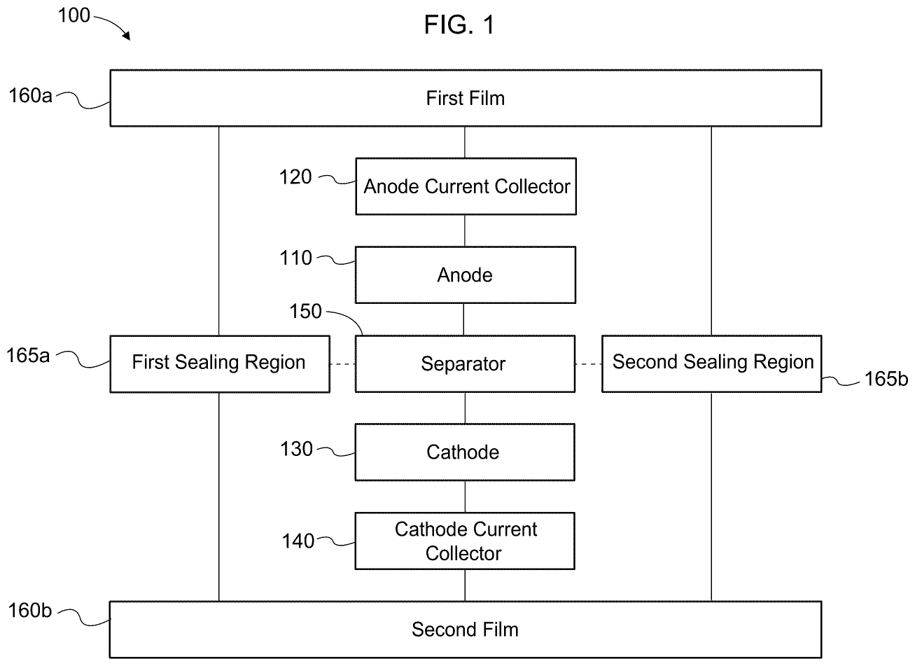

FIG. 1 is a block diagram of an electrochemical cell 100, according to an embodiment. As shown, the electrochemical cell 100 includes an anode 110 disposed on an anode current collector 120, a cathode 130 disposed on a cathode current collector 140, and a separator 150 disposed between the anode 110 and the cathode 130. A first film 160a is coupled to the anode current collector 120 and a second film 160b is coupled to the cathode current collector 140. The first film 160a is coupled to the second film 160b via a first sealing region 165a and a second sealing region 165b. The first film 160a and the second film 160b form a pouch. In some embodiments, the first sealing region 165a and/or the second sealing region 165b can be coupled to the separator 150.

The anode 110 includes an anode active material. In some embodiments, the anode 110 can include an anode conductive material. In some embodiments, the anode 110 can include a semi-solid anode. In some embodiments, the anode current collector 120 can be composed of copper, aluminum, nickel, titanium, or any combination thereof.

The cathode 130 includes a cathode active material. In some embodiments, the cathode 130 can include a cathode conductive material. In some embodiments, the cathode 130 can include a semi-solid cathode. In some embodiments, the cathode current collector 140 can include aluminum or any other suitable current collector material.

The separator 150 can include any suitable separator that acts as an ion-permeable membrane. In other words, the separator 150 allows exchange of ions while maintaining physical separation of the cathode 130 and the anode 110. For example, the separator 150 can be any conventional membrane that is capable of ion transport. In some embodiments, the separator 150 is a liquid impermeable membrane that permits the transport of ions therethrough, namely a solid or gel ionic conductor. In some embodiments the separator 150 is a porous polymer membrane infused with a liquid electrolyte that allows for the shuttling of ions between the cathode 130 and anode 110 electroactive materials, while preventing the transfer of electrons. In some embodiments, the separator 150 can be a microporous membrane that prevents particles forming the positive and negative electrode compositions from crossing the membrane. For example, the membrane materials can be selected from polyethyleneoxide (PEO) polymer in which a lithium salt is complexed to provide lithium conductivity, or NAFION™ membranes which are proton conductors. For example, PEO based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. In some embodiments, the separator 150 can include polyethylene, polypropylene, polyimide, or any combination thereof. In some embodiments, the separator 150 can be made from a ceramic such as alumina. In some embodiments, the separator 150 can be made from a suitable polymer with ceramic particles dispersed within the separator 150 or deposited on one or both surfaces of the separator 150.

In some embodiments, the first film 160a and/or the second film 160b can be coupled to the separator 150 via the first sealing region 165a and/or the second sealing region 165b. In some embodiments, the first sealing region 165a and/or the second sealing region 165b can be physically coupled to the separator 150. In other words, the separator 150 can be at least partially contained by the bonding between the first film 160a and the second film 160b. The first sealing region 165a has a first failure pressure and the second sealing region 165b has a second failure pressure, the second failure pressure being lower than the first failure pressure. Control of the failure pressure can help localize a failure, for example, to allow gas to be vented at predetermined location so as to prevent thermal runaway and may allow escape of the gases via a preferred flow path. In some embodiments, the first sealing region 165a can have a different width from the second sealing region 165b.

In some embodiments, the first sealing region 165a and/or the second sealing region 165b can fail at a pressure of at least about 10 kPa (gauge), at least about 20 kPa, at least about 30 kPa, at least about 40 kPa, at least about 50 kPa, at least about 60 kPa, at least about 70 kPa, at least about 80 kPa, at least about 90 kPa, at least about 100 kPa, at least about 200 kPa, at least about 300 kPa, at least about 400 kPa, at least about 500 kPa, at least about 600 kPa, at least about 700 kPa, at least about 800 kPa, at least about 900 kPa, at least about 1,000 kPa, at least about 2,000 kPa, at least about 3,000 kPa, or at least about 4,000 kPa. In some embodiments, the first sealing region 165a and/or the second sealing region 165b can fail at a pressure of no more than about 5,000 kPa, no more than about 4,000 kPa, no more than about 3,000 kPa, no more than about 2,000 kPa, no more than about 1,000 kPa, no more than about 900 kPa, no more than about 800 kPa, no more than about 700 kPa, no more than about 600 kPa, no more than about 500 kPa, no more than about 400 kPa, no more than about 300 kPa, no more than about 200 kPa, no more than about 100 kPa, no more than about 90 kPa, no more than about 80 kPa, no more than about 70 kPa, no more than about 60 kPa, no more than about 50 kPa, no more than about 40 kPa, no more than about 30 kPa, or no more than about 20 kPa. Combinations of the above-referenced failure pressures are also possible (e.g., at least about 10 kPa and no more than about 5,000 kPa or at least about 200 kPa and no more than about 1,000 kPa), inclusive of all values and ranges therebetween. In some embodiments, the first sealing region 165a and/or the second sealing region 165b can fail at a pressure of about 10 kPa, about 20 kPa, about 30 kPa, about 40 kPa, about 50 kPa, about 60 kPa, about 70 kPa, about 80 kPa, about 90 kPa, about 100 kPa, about 200 kPa, about 300 kPa, about 400 kPa, about 500 kPa, about 600 kPa, about 700 kPa, about 800 kPa, about 900 kPa, about 1,000 kPa, about 2,000 kPa, about 3,000 kPa, about 4,000 kPa, or about 5,000 kPa.

In some embodiments, the difference between the failure pressure of the first sealing region 165a and the failure pressure of the second sealing region 165b can be at least about 1 kPa, at least about 2 kPa, at least about 3 kPa, at least about 4 kPa, at least about 5 kPa, at least about 6 kPa, at least about 7 kPa, at least about 8 kPa, at least about 9 kPa, at least about 10 kPa, at least about 20 kPa, at least about 30 kPa, at least about 40 kPa, at least about 50 kPa, at least about 60 kPa, at least about 70 kPa, at least about 80 kPa, at least about 90 kPa, at least about 100 kPa, at least about 200 kPa, at least about 300 kPa, at least about 400 kPa, at least about 500 kPa, at least about 600 kPa, at least about 700 kPa, at least about 800 kPa, or at least about 900 kPa. In some embodiments, the difference between the failure pressure of the first sealing region 165a and the failure pressure of the second sealing region 165b can be no more than about 1,000 kPa, no more than about 900 kPa, no more than about 800 kPa, no more than about 700 kPa, no more than about 600 kPa, no more than about 500 kPa, no more than about 400 kPa, no more than about 300 kPa, no more than about 200 kPa, no more than about 100 kPa, no more than about 90 kPa, no more than about 80 kPa, no more than about 70 kPa, no more than about 60 kPa, no more than about 50 kPa, no more than about 40 kPa, no more than about 30 kPa, no more than about 20 kPa, no more than about 10 kPa, no more than about 9 kPa, no more than about 8 kPa, no more than about 7 kPa, no more than about 6 kPa, no more than about 5 kPa, no more than about 4 kPa, no more than about 3 kPa, or no more than about 2 kPa. Combinations of the above-referenced differences between the failure pressure of the first sealing region 165a and the failure pressure of the second sealing region 165b are also possible (e.g., at least about 1 kPa and no more than about 1,000 kPa or at least about 10 kPa and no more than about 500 kPa), inclusive of all values and ranges therebetween. In some embodiments, the difference between the failure pressure of the first sealing region 165a and the failure pressure of the second sealing region 165b can be about 1 kPa, about 2 kPa, about 3 kPa, about 4 kPa, about 5 kPa, about 6 kPa, about 7 kPa, about 8 kPa, about 9 kPa, about 10 kPa, about 20 kPa, about 30 kPa, about 40 kPa, about 50 kPa, about 60 kPa, about 70 kPa, about 80 kPa, about 90 kPa, about 100 kPa, about 200 kPa, about 300 kPa, about 400 kPa, about 500 kPa, about 600 kPa, about 700 kPa, about 800 kPa, about 900 kPa, or about 1,000 kPa.

In some embodiments, the different failure pressures of the first sealing region 165a and the second sealing region 165b may be obtained by sealing the two regions at different sealing pressures. For example, in some embodiments, the first sealing region 165a can be sealed at a first sealing pressure and the second sealing region 165b can be sealed at a second sealing pressure to cause the first sealing region 165a to have a first sealing pressure that is greater than the second sealing pressure of the second sealing region 165b. In some embodiments, the first sealing pressure can be greater than the second sealing pressure by a factor of about 1.1, about 1.2, about 1.3, about 1.4, about 1.5, about 1.6, about 1.7, about 1.8, about 1.9, about 2, of about 2.1, about 2.2, about 2.3, about 2.4, about 2.5, about 2.6, about 2.7, about 2.8, about 2.9, about 3, of about 3.1, about 3.2, about 3.3, about 3.4, about 3.5, about 3.6, about 3.7, about 3.8, about 3.9, about 4, of about 4.1, about 4.2, about 4.3, about 4.4, about 4.5, about 4.6, about 4.7, about 4.8, about 4.9, or about 5, inclusive of all values and ranges therebetween.

In some embodiments, the first sealing region 165a can be sealed under a first sealing force and the second sealing region 165b can be sealed under a second sealing force to cause the first sealing region 165a to have the first failure pressure that is greater than the second failure pressure of the second sealing region 165b. In some embodiments, the first sealing force can be greater than the second sealing force by a factor of about 1.1, about 1.2, about 1.3, about 1.4, about 1.5, about 1.6, about 1.7, about 1.8, about 1.9, about 2, of about 2.1, about 2.2, about 2.3, about 2.4, about 2.5, about 2.6, about 2.7, about 2.8, about 2.9, about 3, of about 3.1, about 3.2, about 3.3, about 3.4, about 3.5, about 3.6, about 3.7, about 3.8, about 3.9, about 4, of about 4.1, about 4.2, about 4.3, about 4.4, about 4.5, about 4.6, about 4.7, about 4.8, about 4.9, or about 5, inclusive of all values and ranges therebetween. In some embodiments, the force applied to the first sealing region 165a and/or the second sealing region 165b can be about 5 N, about 10 N, about 20 N, about 30 N, about 40 N, about 50 N, about 60 N, about 70 N, about 80 N, about 90 N, about 100 N, about 200 N, about 300 N, about 400 N, about 500 N, about 600 N, about 700 N, about 800 N, about 900 N, about 1,000 N, about 2,000 N, about 3,000 N, about 4,000 N, about 5,000 N, about 6,000 N, about 7,000 N, about 8,000 N, about 9,000 N, or about 10,000 N, inclusive of all values and ranges therebetween.

In some embodiments, the first sealing region 165a can be sealed for a first duration and the second sealing region 165b can be sealed for a second duration to cause the first sealing region 165a to have the first failure pressure that is greater than the second failure pressure of the second sealing region 165b. In some embodiments, the first duration can be greater than the second duration by a factor of about 1.1, about 1.2, about 1.3, about 1.4, about 1.5, about 1.6, about 1.7, about 1.8, about 1.9, about 2, of about 2.1, about 2.2, about 2.3, about 2.4, about 2.5, about 2.6, about 2.7, about 2.8, about 2.9, about 3, of about 3.1, about 3.2, about 3.3, about 3.4, about 3.5, about 3.6, about 3.7, about 3.8, about 3.9, about 4, of about 4.1, about 4.2, about 4.3, about 4.4, about 4.5, about 4.6, about 4.7, about 4.8, about 4.9, or about 5, inclusive of all values and ranges therebetween. In some embodiments, the first duration and/or the second duration can be about 0.1 seconds, about 0.2 seconds, about 0.3 seconds, about 0.4 seconds, about 0.5 seconds, about 0.6 seconds, about 0.7 seconds, about 0.8 seconds, about 0.9 seconds, about 1 second, about 2 seconds, about 3 seconds, about 4 seconds, about 5 seconds, about 6 seconds, about 7 seconds, about 8 seconds, about 9 seconds, about 10 seconds, about 20 seconds, about 30 seconds, about 40 seconds, about 50 seconds, about 1 minute, about 2 minutes, about 3 minutes, about 4 minutes, about 5 minutes, about 6 minutes, about 7 minutes, about 8 minutes, about 9 minutes, or about 10 minutes, inclusive of all values and ranges therebetween.

In some embodiments, the first sealing region 165a can be sealed at a first temperature and the second sealing region 165b can be sealed at a second temperature to cause the first sealing region 165a to have the first failure pressure that is greater than the second failure pressure of the second sealing region 165b. In some embodiments, the first temperature can be greater than the second temperature by about 10° C., about 20° C., about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C., inclusive of all values and ranges therebetween.

In some embodiments, the anode 110, the anode current collector 120, the cathode 130, the cathode current collector 140, and the separator 150 can be wound into a spiral shape, such that the electrochemical cell 100 has a cylindrical shape. In some embodiments, multiple electrochemical cells can be placed in the pouch. In some embodiments, multiple electrochemical cells can be stacked into the pouch. In some embodiments, the stacked electrochemical cells can be connected in parallel. In some embodiments, the stacked electrochemical cells can be connected in series. In some embodiments, the stacked electrochemical cells can be stacked with anodes and anode current collectors on either terminal end of the stack (i.e., a parallel connection). In some embodiments, the stacked electrochemical cells can be stacked with cathodes and cathode current collectors on either terminal end of the stack (i.e., a parallel connection).

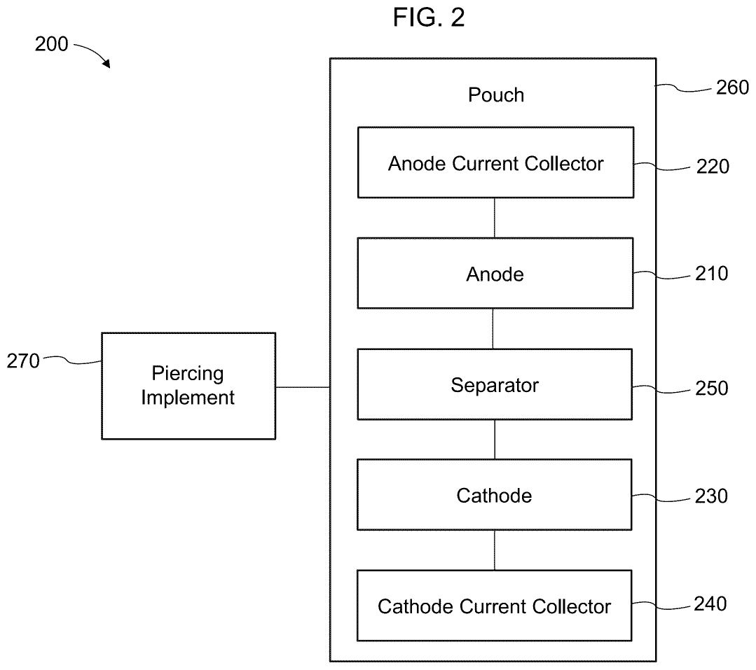

FIG. 2 is a block diagram of an electrochemical cell 200, according to an embodiment. As shown, the electrochemical cell 200 includes an anode 210 disposed on an anode current collector 220, a cathode 230 disposed on a cathode current collector 240, and a separator 250 disposed between the anode 210 and the cathode 230. The anode 210, the anode current collector 220, the cathode 230, the cathode current collector 240, and the separator 250 are disposed in a pouch 260. A piercing implement 270 is coupled to the pouch 260. In some embodiments, the anode 210, the anode current collector 220, the cathode 230, the cathode current collector 240, and the separator 250 can be the same or substantially similar to the anode 110, the anode current collector 120, the cathode 130, the cathode current collector 140, and the separator 150, as described above with reference to FIG. 1. Thus, certain aspects of the anode 210, the anode current collector 220, the cathode 230, the cathode current collector 240, and the separator 250 are not described in further detail herein.

In some embodiments, the pouch 260 can include a first film and a second film joined via a sealing region, the same or substantially similar to the first film 160a and the second film 160b, as described above with reference to FIG. 1. In some embodiments, the piercing implement 270 can include one or more spikes or sharp surfaces. When the pouch 260 inflates or expands beyond an expansion threshold, the pouch 260 interacts with the piercing implement 270 and ruptures. In some embodiments, the rupturing can occur at the location where the piercing implement 270 contacts the expanding pouch 260 and pierces therethrough. In some embodiments, the piercing implement 270 can be positioned to limit the expansion of the pouch 260. In some embodiments, the piercing implement 270 can be incorporated into a frame (not shown). The frame can be disposed around the electrochemical cell 200.

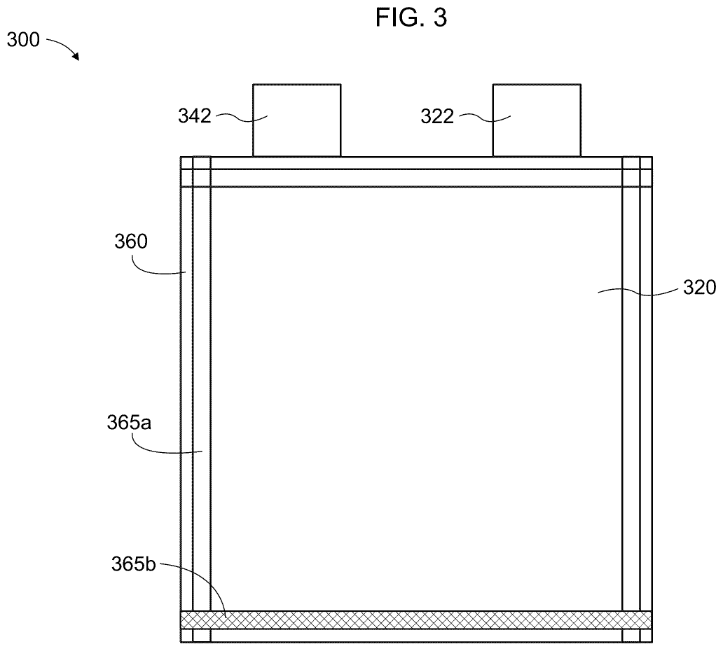

FIG. 3 is an illustration of an electrochemical cell 300 with a failure mechanism, according to an embodiment. The electrochemical cell 300 includes an anode (not shown) disposed on an anode current collector 320, a cathode (not shown) disposed on a cathode current collector (not shown), and a separator (not shown) disposed between the anode and the cathode. The anode, the anode current collector 320, the cathode, the cathode current collector, and the separator are disposed in a pouch 360. An anode tab 322 is coupled to the anode current collector 320 and protrudes to the outside of the pouch 360. A cathode tab 342 is coupled to the cathode current collector and protrudes to the outside of the pouch 360. The pouch 360 includes a first sealing region 365a and a second sealing region 365b. In some embodiments, the anode, the anode current collector 320, the cathode, the cathode current collector, the separator, the first sealing region 365a, and the second sealing region 365b can be the same or substantially similar to the anode 110, the anode current collector 120, the cathode 130, the cathode current collector 140, the separator 150, the first sealing region 165a, and the second sealing region 165b, as described above with reference to FIG. 1. Thus, certain aspects of the anode, the anode current collector 320, the cathode, the cathode current collector, the separator, the first sealing region 365a, and the second sealing region 365b are not described in greater detail herein.

The first sealing region 365a has a first failure pressure and the second sealing region 365b has a second failure pressure. The second failure pressure is lower than the first failure pressure. As shown, the pouch 360 has four sides and the second sealing region 365b encompasses one of the four sides of the pouch 360. In some embodiments, the second sealing region 365b can encompass two sides of the pouch 360. In some embodiments, the second sealing region 365b can encompass three sides of the pouch 360. As shown, the second sealing region 365b extends a full length of one side of the pouch 360. In some embodiments, the second sealing region 365b can extend a portion of one side of the pouch 360.

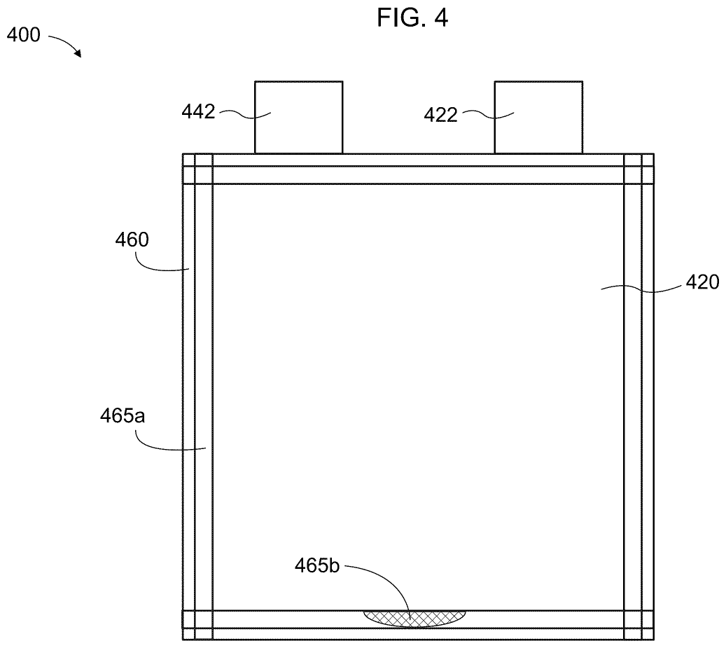

FIG. 4 shows an electrochemical cell 400 with a failure mechanism, according to an embodiment. The electrochemical cell 400 includes an anode (not shown) disposed on an anode current collector 420, a cathode (not shown) disposed on a cathode current collector (not shown), and a separator (not shown) disposed between the anode and the cathode. The anode, the anode current collector 420, the cathode, the cathode current collector, and the separator are disposed in a pouch 460. An anode tab 422 is coupled to the anode current collector 420 and protrudes to the outside of the pouch 460. A cathode tab 442 is coupled to the cathode current collector and protrudes to the outside of the pouch 460. The pouch 460 includes a first sealing region 465a and a second sealing region 465b. In some embodiments, the anode, the anode current collector 420, the anode tab 422, the cathode, the cathode current collector, the cathode tab 442, the separator, the pouch 460, the first sealing region 465a, and the second sealing region 465b can be the same or substantially similar to the anode, the anode current collector 320, the anode tab 322, the cathode, the cathode current collector, the cathode tab 342, the separator, the pouch 360, the first sealing region 365a, and the second sealing region 365b, as described above with reference to FIG. 3. Thus, certain aspects of the anode, the anode current collector 420, the anode tab 422, the cathode, the cathode current collector, the cathode tab 442, the separator, the pouch 460, the first sealing region 465a, and the second sealing region 465b are not described in greater detail herein.

As shown, the second sealing region 465b includes a portion of one of the sides of the pouch 460. As shown, the second sealing region 465b has a semicircular shape, such that it has a first width on an interior side of the pouch 460 and a second width on an exterior side of the pouch, the first width greater than the second width. In some embodiments, the width of the second sealing region 465b can be greater on the exterior side of the pouch 460 than on the interior side of the pouch 460. In some embodiments, the second sealing region 465b can have a rectangular shape, such that its interior width is the same as its exterior width. In some embodiments, the second sealing region 465b can have a pinhole width. In some embodiments, the second sealing region can have a width of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, about 1 m, about 1.5 m, about 2 m, about 2.5 m, about 3 m, about 3.5 m, about 4 m, about 4.5 m, or about 5 m, inclusive of all values and ranges therebetween.

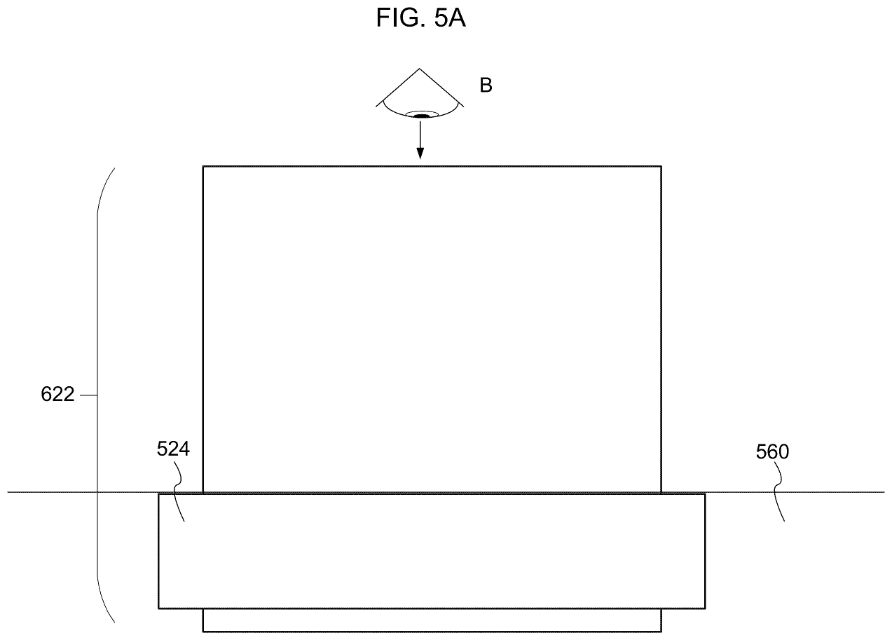

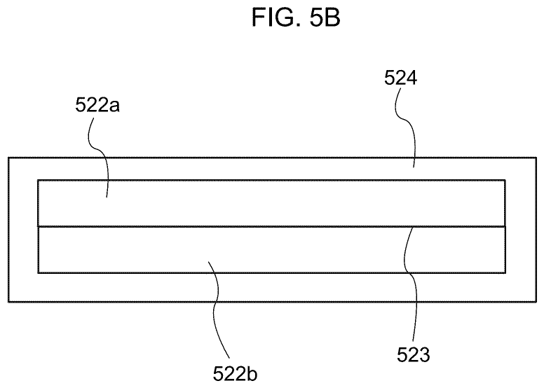

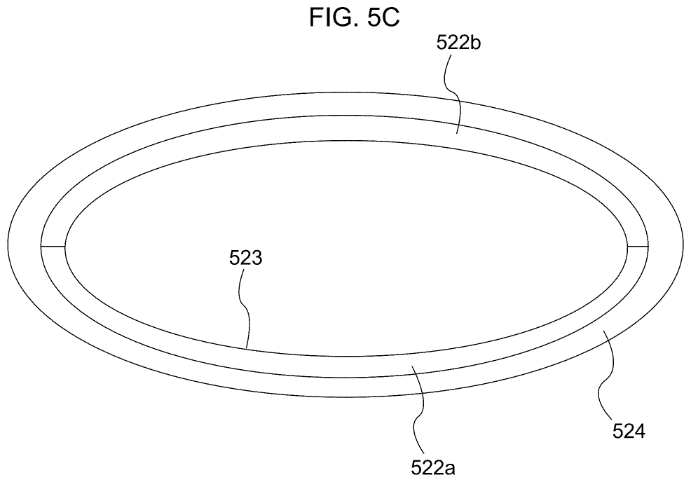

FIGS. 5A-5C are illustrations of an anode tab 522, according to an embodiment. FIG. 5A shows a plan view of the anode tab 522. FIG. 5B shows an outer perspective of the anode tab 522 from the vantage of an eye labeled ‘B’ in FIG. 5A. FIG. 5B shows the anode tab 522 prior to failure while FIG. 5C shows the anode tab 522 after failure. As shown, the anode tab 522 includes a first section 522a and a second section 522b bonded together via a bonding compound 523 (e.g., an adhesive, a glue, a polymer, etc.). A sealant 524 is disposed around the outside of the anode tab 522. A pouch 560 is shown for context. In some embodiments, the pouch 560 can be the same or substantially similar to the pouch 360, as described above with reference to FIG. 3. Thus, certain aspects of the pouch 560 are not described in greater detail herein. The sealant 524 is located at an interface between the pouch 560 and the anode tab 522.

The bonding compound 523 has a failure pressure lower than a failure pressure of the sealing region 524. As shown, the first section 522a and the second section 522b are two separate pieces of material. In some embodiments, the first section 522a and the second section 522b can be part of the same piece of material with a slit cut in the middle, leaving adjoining sections on either side of the slit. FIG. 5C depicts the anode tab 522 after a failure has occurred in its electrochemical cell. The first section 522a has become at least partially or completely dissociated from the second section 522b. In other words, the anode tab 522 has opened and gas from inside the pouch 560 exits via the opening formed by the separation of the first section 522a and the second section 522b. As show, FIGS. 5A-5C depict components of an anode. In some embodiments, a cathode tab (not shown) can include any of the components described above.

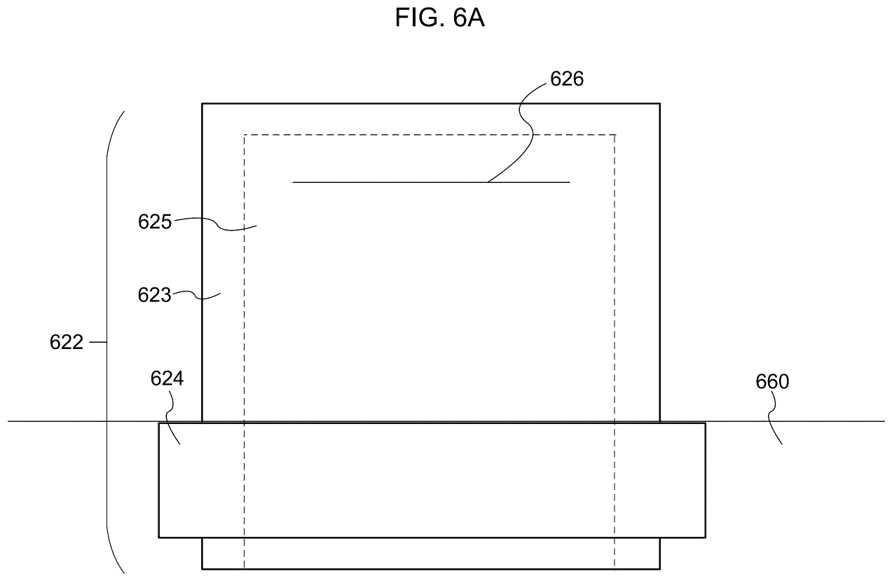

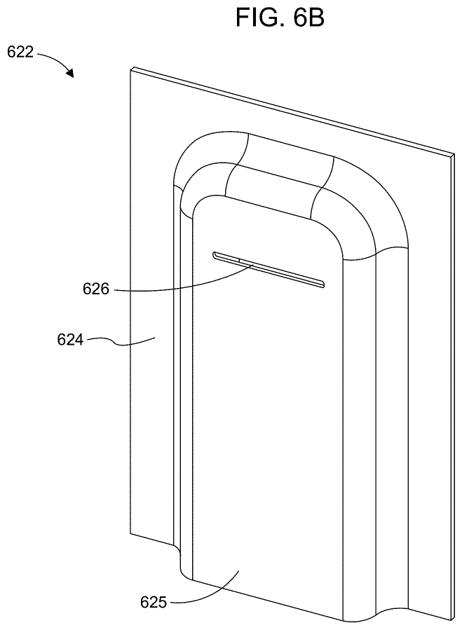

FIGS. 6A-6B are illustrations of an anode tab 622, according to an embodiment. As shown, the anode tab 622 includes a sealing region 623, an unsealed region 625, and a vent 626. The vent 626 includes a selectively weakened area in the anode tab 622 that fails above a critical pressure threshold. The vent 626 may be formed by coining, stamping, laser ablation, or any other suitable process. A sealant 624 is disposed around the outside of the anode tab 622. A pouch 660 is shown for context. In some embodiments, the anode tab 622, the sealant 624, and the pouch 660 can be the same or substantially similar to the anode tab 522, the sealant 524, and the pouch 560, as described above with reference to FIGS. 5A-5C. Thus, certain aspects of the anode tab 622, the sealant 625, and the pouch 660 are not described in greater detail herein.

FIG. 6A shows the anode tab 622 prior to failure, while FIG. 6B shows the anode tab 622 after failure. The pouch 660 is fluidically coupled to the unsealed region 625 of the anode tab 622. Upon reaching a threshold pressure inside the pouch 660 the unsealed region 625 inflates (as shown in FIG. 6B), such that a first portion of the unsealed region 625 becomes dissociated from a second portion of the unsealed region 625. Gas is then released via the opening 626.

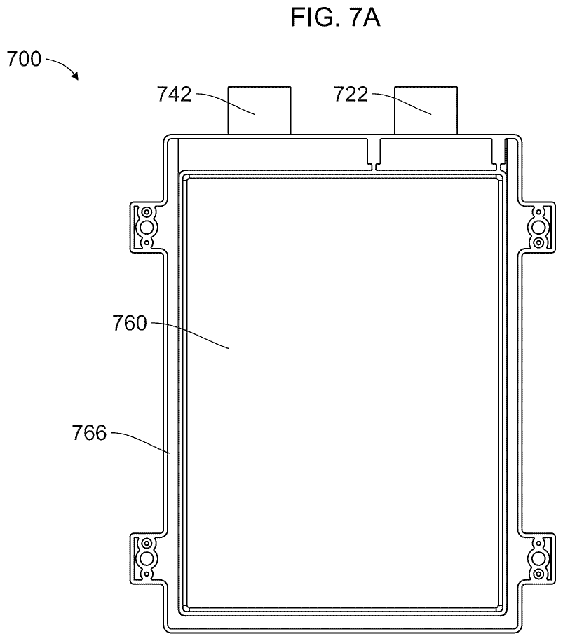

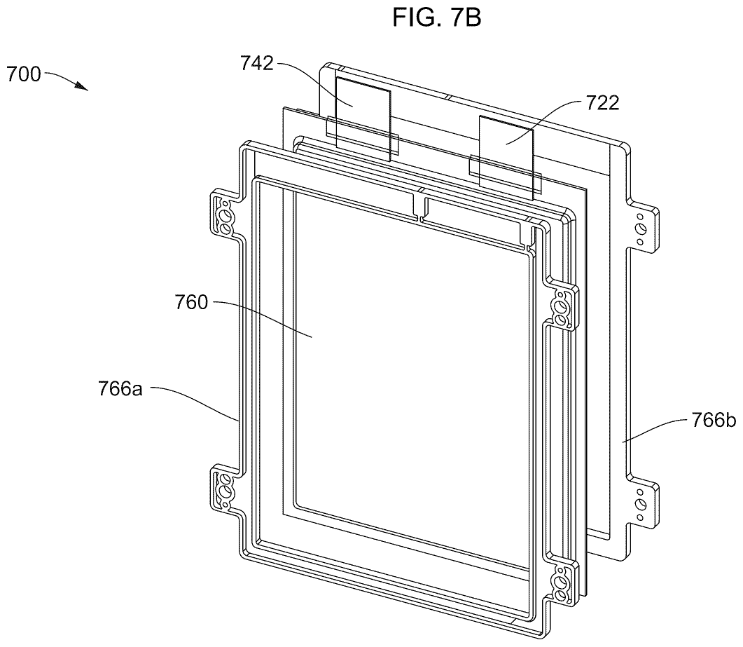

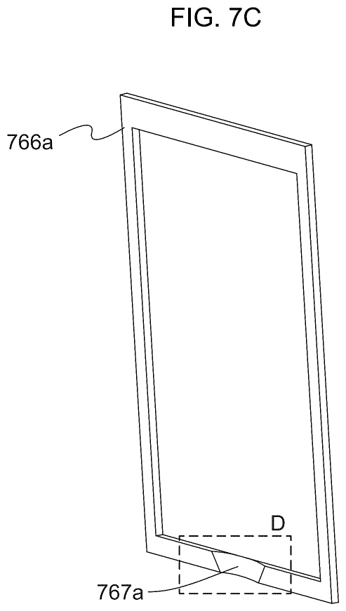

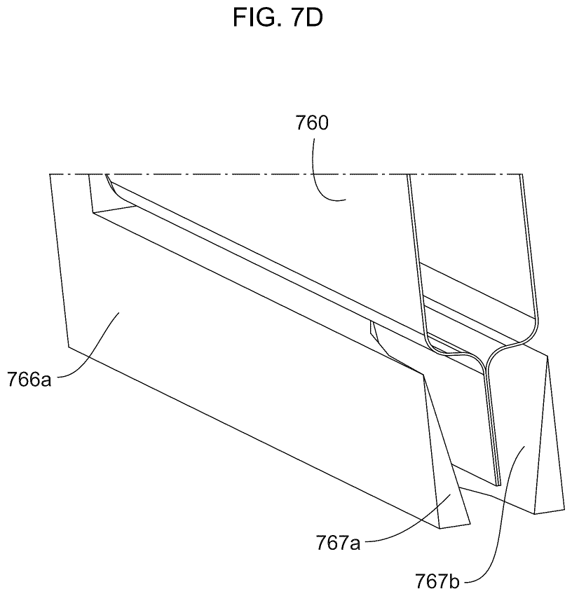

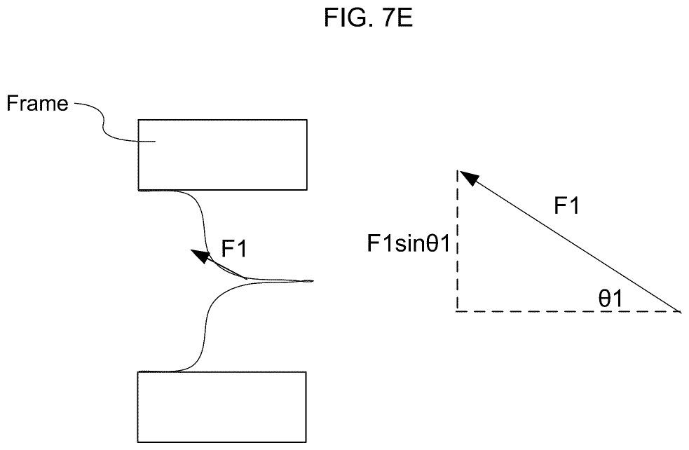

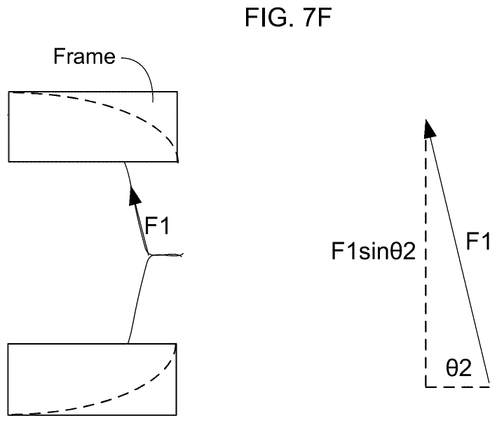

FIGS. 7A-7F show an electrochemical cell 700 with a failure mechanism, and various components thereof, according to an embodiment. The electrochemical cell 700 includes an anode (not shown) disposed on an anode current collector (not shown), a cathode (not shown) disposed on a cathode current collector (not shown), and a separator (not shown) disposed between the anode and the cathode. The anode, the anode current collector, the cathode, the cathode current collector, and the separator are disposed in a pouch 760. An anode tab 722 is coupled to the anode current collector and protrudes to the outside of the pouch 760. A cathode tab 742 is coupled to the cathode current collector and protrudes to the outside of the pouch 760. A frame 766 is disposed around the pouch 760. In some embodiments, the anode, the anode current collector, the anode tab 722, the cathode, the cathode current collector, the cathode tab 742, the separator, and the pouch 760 can be the same or substantially similar to the anode, the anode current collector 320, the anode tab 322, the cathode, the cathode current collector, the cathode tab 342, the separator, and the pouch 360, as described above with reference to FIG. 3. Thus, certain aspects of the anode, the anode current collector, the anode tab 722, the cathode, the cathode current collector, the cathode tab 742, the separator, and the pouch 760 are not described in greater detail herein.

FIG. 7A shows a plan view of the electrochemical cell 700, while FIG. 7B shows an auxiliary view of the electrochemical cell 700 with the frame 766 separated into a first portion 766a and a second portion 766b. In some embodiments, the first portion 766a can be bonded to the second portion 766b via fasteners (e.g., screws). FIG. 7C shows an auxiliary view of an interior side of the first portion 766a of the frame 766. As shown, the first portion 766a includes a reduced section 767a, in which a cross sectional area of the material that forms the first portion 766a is less than a cross sectional area of other sections of the first portion 766a (e.g., the reduced section 767a has a first width that is smaller than a second width of other sections of the first portion 766a). FIG. 7D shows a close-up view of the interaction between the frame 766 and the pouch 760. The second portion 766b includes a reduced section 767b. In some embodiments, the reduced section 767b can be the same or substantially similar to the reduced section 767a. In some embodiments, the reduced sections 767a, 767b can be formed via machining. In some embodiments, the reduced sections 767a, 767b can be formed via a mold. The reduced sections 767a, 767b allow an unencumbered or a less encumbered expansion of the pouch 760 than the remainder of the frame 766.

FIG. 7E depicts expansion of a pouch encumbered by a frame, while FIG. 7F depicts expansion of a pouch less encumbered by a frame (i.e., with reduced sections). As shown in FIG. 7E, the frame inhibits expansion of the pouch, and limits the angle θ1 of the splitting between a top portion and a bottom portion of the pouch. In FIG. 7F, a portion of the frame is removed, as indicated by the dotted lines. Therefore, the angle θ2 of the splitting between the top portion and the bottom portion of the pouch is less confined than the angle θ1. The vertical component of the force F1 applied to the expansion of the pouch is F1 sin (θ1) in FIG. 7E and F1 sin (θ2) in FIG. 7F. F1 sin (θ2) is greater than F1 sin (θ1), so the top portion and the bottom portion are more prone to seal failure and thus venting under the greater vertical force.

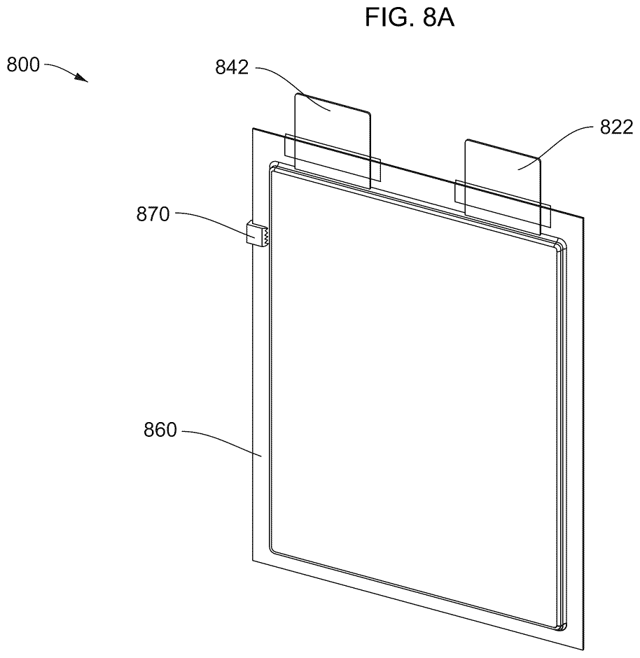

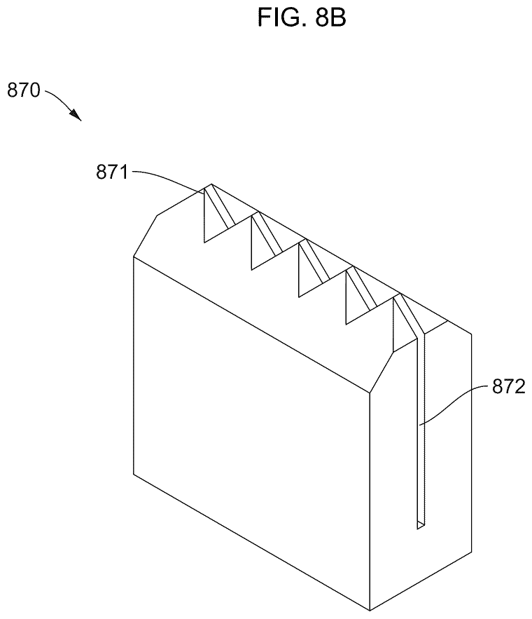

FIGS. 8A-8B are illustrations of an electrochemical cell 800 with a failure mechanism, according to an embodiment. The electrochemical cell 800 includes an anode (not shown) disposed on an anode current collector (not shown), a cathode (not shown) disposed on a cathode current collector (not shown), and a separator (not shown) disposed between the anode and the cathode. The anode, the anode current collector, the cathode, the cathode current collector, and the separator are disposed in a pouch 860. An anode tab 822 is coupled to the anode current collector and protrudes to the outside of the pouch 860. A cathode tab 842 is coupled to the cathode current collector and protrudes to the outside of the pouch 860. A piercing implement 870 is attached to the pouch 860. In some embodiments, the anode, the anode current collector, the anode tab 822, the cathode, the cathode current collector, the cathode tab 842, the separator, and the pouch 860 can be the same or substantially similar to the anode, the anode current collector 320, the anode tab 322, the cathode, the cathode current collector, the cathode tab 342, the separator, and the pouch 360, as described above with reference to FIG. 3. Thus, certain aspects of the anode 810, the anode current collector 820, the anode tab 822, the cathode, the cathode current collector, the cathode tab 842, the separator, and the pouch 860 are not described in greater detail herein.

FIG. 8B shows a detailed view of the piercing implement 870. In some embodiments, the piercing element 870 can be coupled along a sealing region of the pouch 860. As shown, the piercing implement 870 includes teeth 871 for the piercing of the pouch 860. The teeth 871 can rupture the pouch 860 when the pouch 860 expands to a threshold size and/or when a pressure inside the pouch 860 exceeds a threshold pressure. As shown, the teeth 871 are positioned on either side of a slot 872. The piercing implement 870 fits onto the pouch 860 by inserting a portion of the pouch 860 into the slot 872. In some embodiments, the piercing implement 870 can be bonded to the pouch 860 (e.g., via an adhesive, heat sealing, heat stake, etc.). In some embodiments, the piercing implement 870 can be held in place via friction. In some embodiments, the piercing implement 870 can be placed at any location along the outside of the pouch 860. In some embodiments, the piercing implement 870 can be formed from a mold. In some embodiments, the piercing implement 870 can have a flexibility to accommodate various cell designs.

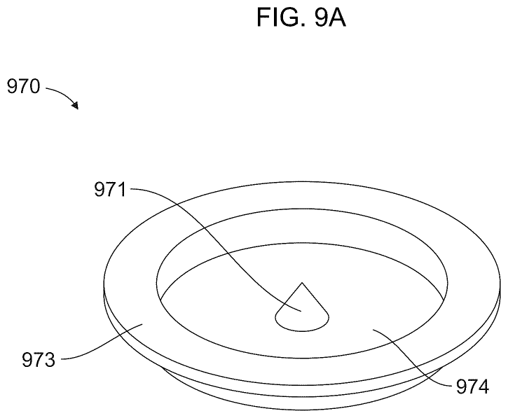

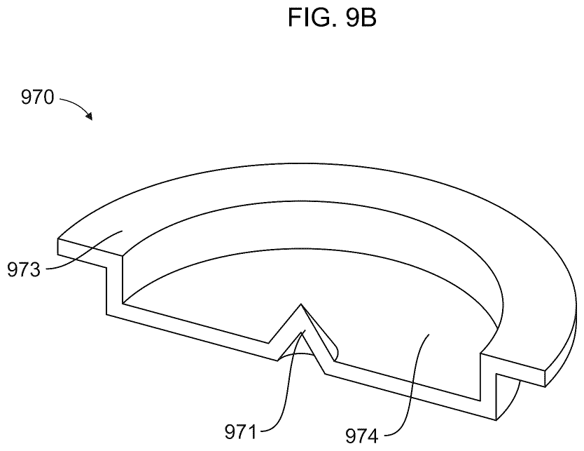

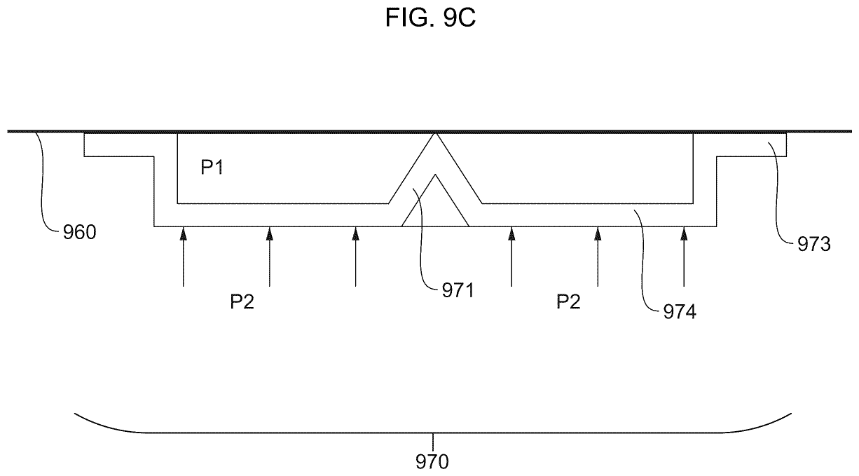

FIGS. 9A-9C show a piercing implement 970, according to an embodiment. As shown, the piercing implement 970 includes a prong 971, a bonding pad 973, and a flexible membrane 974. The prong 971 is disposed on the flexible membrane 974. FIG. 9A shows an auxiliary view of the piercing implement 970. FIG. 9B shows an auxiliary view of the piercing implement 970 cut along a cross section. FIG. 9C shows the piercing implement 970 affixed to an interior of a pouch 960.

In use, the piercing implement 970 is placed inside the pouch 960 with the bonding pad 973 adhering to the interior surface of the pouch 960. Pressure builds up inside the pouch 960 and presses the outer surface of the flexible membrane 974. The prong 971 is then propelled into the interior surface of the pouch 960 to pierce the pouch 960. The piercing implement 970 thereby acts as a pressure actuated button. In some embodiments, the piercing implement 970 can be bonded to the interior surface of the pouch 960 during assembly of the cell. In some embodiments, the bonding pad 973 can be sealed to the inside of the pouch, creating a sealed cavity with internal pressure P1, as shown in FIG. 9C. As pressure P2 in the pouch 960 increases to greater than P1, the flexible membrane 974 flexes and drives the prong 971 into the pouch 960.

As shown, the bonding pad 973 has a circular shape surrounding the flexible membrane 974. In some embodiments, the bonding pad 973 can have an elliptical shape. In some embodiments, the bonding pad 973 can have a rectangular shape, a square shape, an oval shape, a rectangular shape with rounded edges, a square shape with rounded edges, or any other suitable shape.

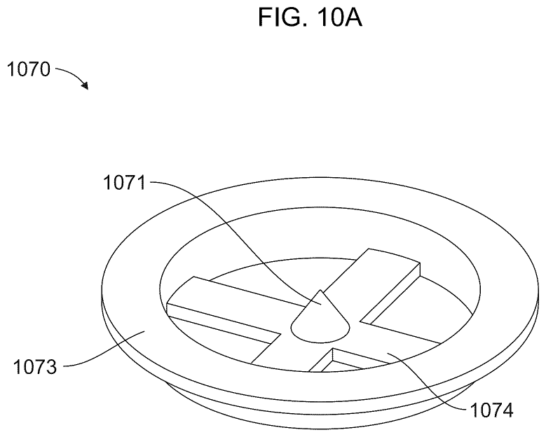

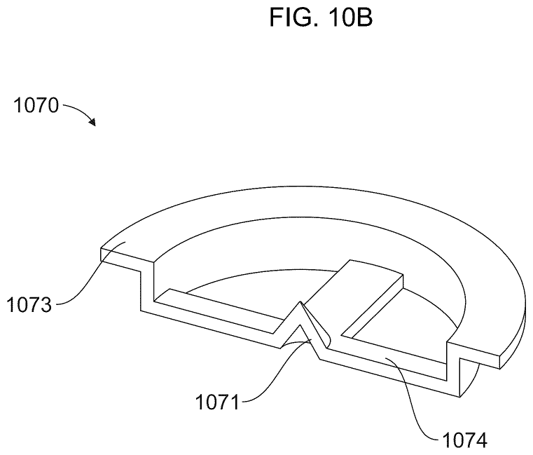

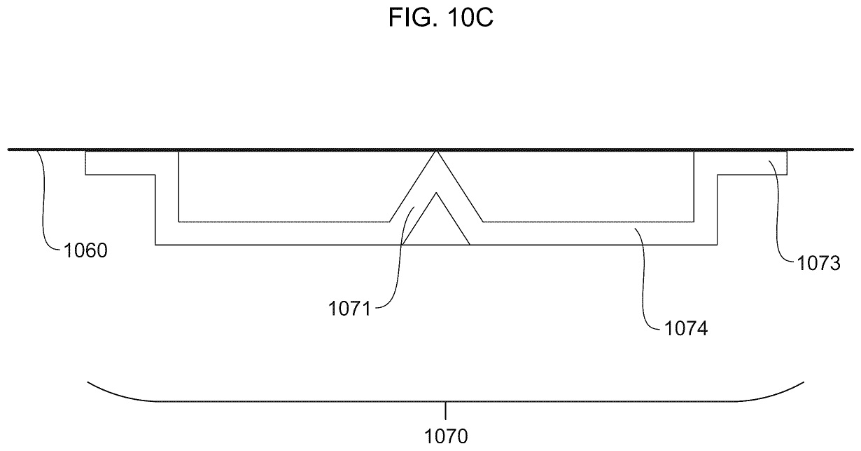

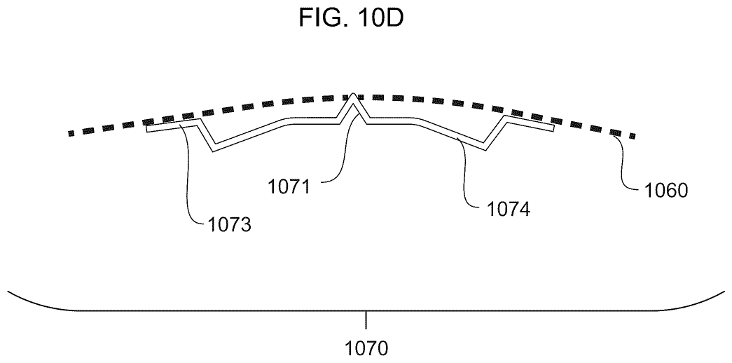

FIGS. 10A-10D show a piercing implement 1070, according to an embodiment. As shown, the piercing implement 1070 includes a prong 1071, a bonding pad 1073, and a flexible surface 1074. In some embodiments, the prong 1071, the bonding pad 1073, and the flexible surface 1074 can be the same or substantially similar to the prong 971, the bonding pad 973, and the flexible surface 974, as described above with reference to FIGS. 9A-9C. Thus, certain aspects of the prong 1071, the bonding pad 1073, and the flexible surface 1074 are not described in greater detail herein. FIG. 10A shows an auxiliary view of the piercing implement 1070. FIG. 10B shows an auxiliary view of the piercing implement 1070 cut along a cross section. FIG. 10C shows the piercing implement 1070 affixed to a pouch 1060. In some embodiments, the piercing implement 1070 can be affixed to an interior surface of the pouch 1060. In some embodiments, the piercing implement 1070 can be affixed to an exterior surface of the pouch 1060. FIG. 10D shows a cross-sectional view of the piercing implement 1070 pressed against and piercing the pouch 1060.

The flexible surface 1074 allows upward and downward movement of the prong 1071. In contrast to the piercing implement 970, as described above with reference to FIGS. 9A-9C, the piercing implement 1070 is pressed into the pouch 1060 via deformation of the piercing implement 1070 rather than via a pressure differential between the outside and the inside of a sealed cavity. Upon deformation via pressure buildup in the pouch 1060, the pouch 1060 expands and the deformation of the pouch 1060 causes the piercing implement 1070 to deform. The bonding pad 1073 anchors the piercing implement 1070 to the pouch 1060. As the pouch 1060 inflates, the surface (i.e., the interior surface or the exterior surface) of the pouch 1060 becomes more curved. With the curving of the pouch 1060, the prong 1071 extends toward the surface of the pouch 1060 due to the bending of the flexible surface 1074. The prong 1071 then pierces the pouch 1060.

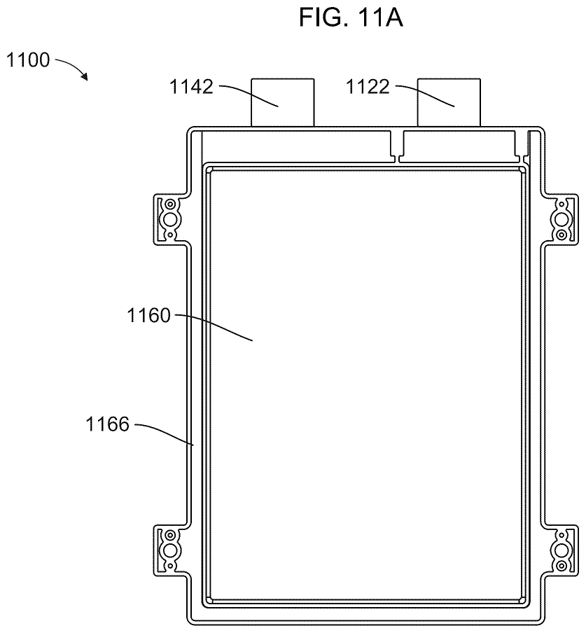

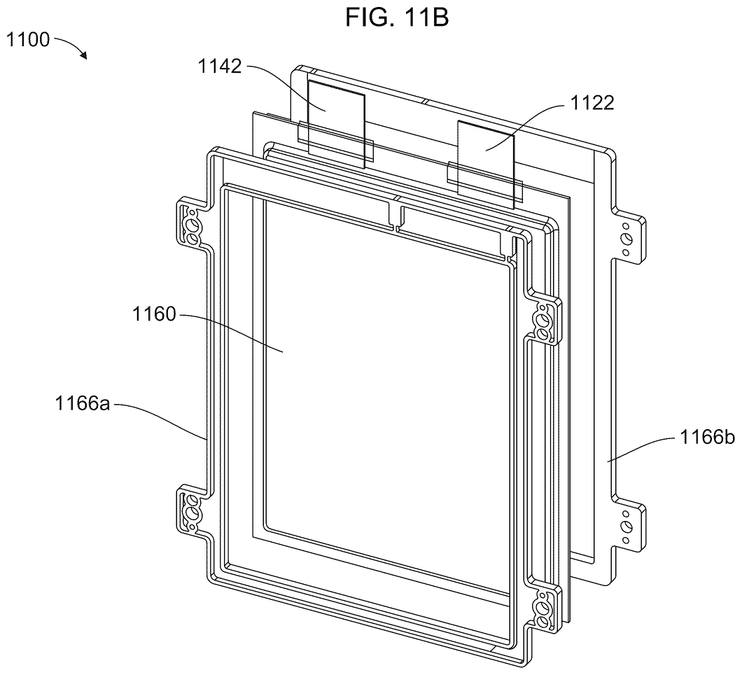

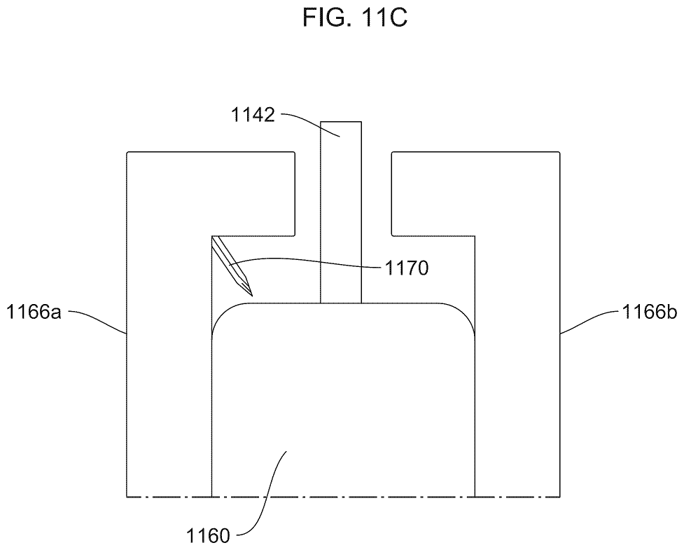

FIGS. 11A-11C are illustrations of an electrochemical cell 1100, according to an embodiment. The electrochemical cell 1100 includes an anode (not shown) disposed on an anode current collector (not shown), a cathode (not shown) disposed on a cathode current collector (not shown), and a separator (not shown) disposed between the anode and the cathode. The anode, the anode current collector, the cathode, the cathode current collector, and the separator are disposed in a pouch 1160. An anode tab 1122 is coupled to the anode current collector and protrudes to the outside of the pouch 1160. A cathode tab 1142 is coupled to the cathode current collector and protrudes to the outside of the pouch 1160. A frame 1166 is disposed around the pouch 1160. A piercing implement 1170 is attached to the frame 1166. In some embodiments, the anode, the anode current collector, the anode tab 1122, the cathode, the cathode current collector, the cathode tab 1142, the separator, the pouch 1160, and the frame 1166 can be the same or substantially similar to the anode, the anode current collector, the anode tab 722, the cathode, the cathode current collector, the cathode tab 742, the separator, the pouch 760, and the frame 766, as described above with reference to FIGS. 7A-7F. Thus, certain aspects of the anode, the anode current collector, the anode tab 1122, the cathode, the cathode current collector, the cathode tab 1142, the separator, the pouch 1160, and the frame 1166 are not described in greater detail herein.

FIG. 11A shows an auxiliary view of the electrochemical cell 1100. FIG. 11B shows an auxiliary exploded view of the electrochemical cell 1100, with a first portion 1166a of the frame 1166 and a second portion 1166b of the frame 1166 separated from each other. FIG. 11C shows a cross-sectional view of an interaction between the piercing implement 1170 and the pouch 1160. Upon expansion of the pouch 1160, the piercing implement 1170 pierces the pouch 1160. In some embodiments, the piercing implement 1170 can include a spike. In some embodiments, the piercing implement 1170 can be composed of metal or any other suitable material. In some embodiments, the piercing implement 1170 can be bonded to the frame 1166. In some embodiments, the piercing implement 1170 can be secured to the frame 1166 via a fastener (e.g., a screw). In some embodiments, the piercing implement 1170 can be secured to a corner of the frame 1166. In some embodiments, the piercing implement 1170 can be secured to an edge of the frame 1166.

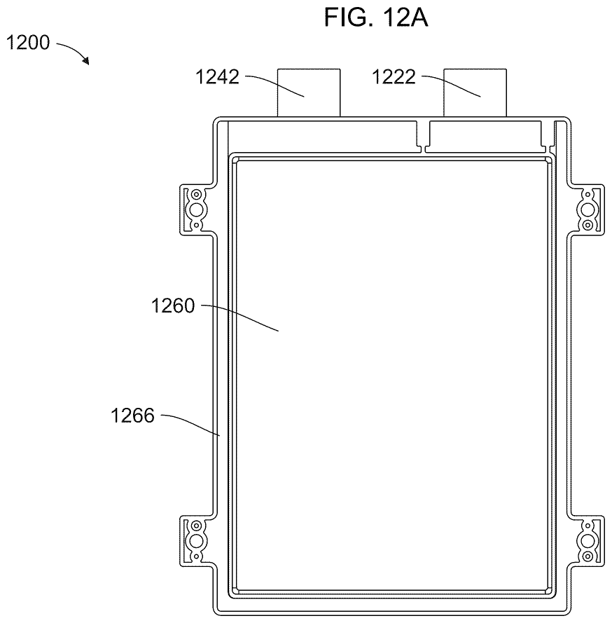

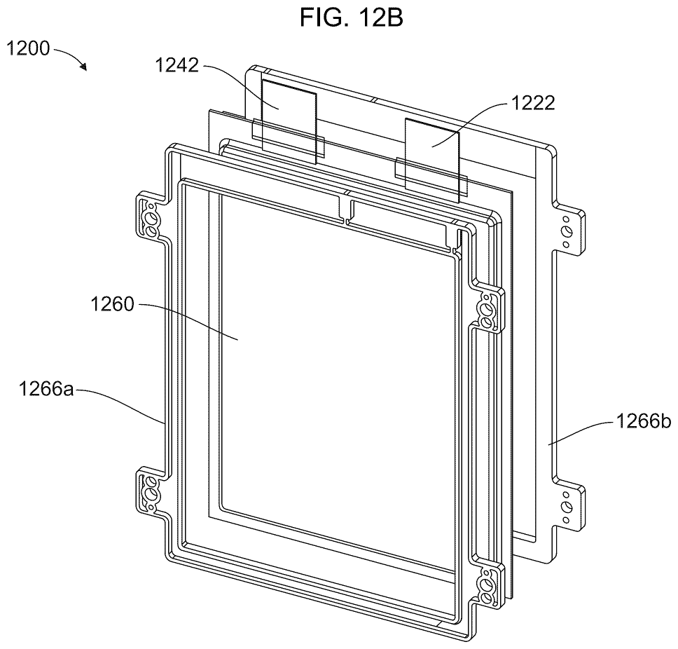

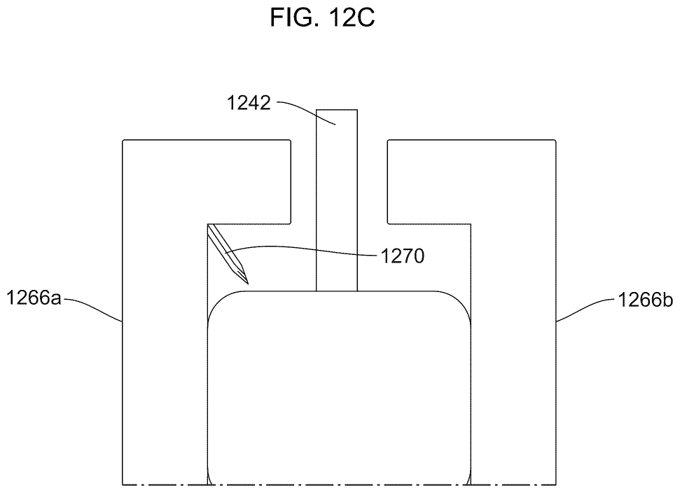

FIGS. 12A-12C are illustrations of an electrochemical cell 1200, according to an embodiment. The electrochemical cell 1200 includes an anode (not shown) disposed on an anode current collector (not shown), a cathode (not shown) disposed on a cathode current collector (not shown), and a separator (not shown) disposed between the anode and the cathode. The anode, the anode current collector, the cathode, the cathode current collector, and the separator are disposed in a pouch 1260. An anode tab 1222 is coupled to the anode current collector and protrudes to the outside of the pouch 1260. A cathode tab 1242 is coupled to the cathode current collector and protrudes to the outside of the pouch 1260. A frame 1266 is disposed around the pouch 1260. A piercing implement 1270 is attached to the frame 1266. The frame 1266 includes a first portion 1266a and a second portion 1266b. In some embodiments, the anode, the anode current collector, the anode tab 1222, the cathode, the cathode current collector, the cathode tab 1242, the separator, the pouch 1260, the frame 1266, the first portion 1266a, the second portion 1266b, and the piercing implement 1270 can be the same or substantially similar to the anode, the anode current collector, the anode tab 1122, the cathode, the cathode current collector, the cathode tab 1142, the separator, the pouch 1160, the frame 1166, the first portion 1166a, the second portion 1166b, and the piercing implement 1170, as described above with reference to FIGS. 11A-11C. Thus, certain aspects of the anode, the anode current collector, the anode tab 1222, the cathode, the cathode current collector, the cathode tab 1242, the separator, the pouch 1260, the frame 1266, the first portion 1266a, the second portion 1266b, and the piercing implement 1270 are not described in greater detail herein.

FIG. 12A shows an auxiliary view of the electrochemical cell 1200. FIG. 12B shows an auxiliary exploded view of the electrochemical cell 1200, with the first portion 1266a and the second portion 1266b separated from each other. FIG. 12C shows a cross-sectional view of an interaction between the piercing implement 1270 and the pouch 1260. As shown, the piercing implement 1270 is molded from the frame 1266. In some embodiments, first portion 1266a can be molded with the piercing implement 1170 integrated therein. In some embodiments, the piercing implement 1170 can be composed of a polymer.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical device, comprising:
an anode disposed on an anode current collector;
a cathode disposed on a cathode current collector;
a separator disposed between the anode and the cathode;
a first film having outer edges extending beyond outer edges of the anode current collector; and
a second film having outer edges extending beyond outer edges of the cathode current collector, the second film bonded to the first film along a sealing region to form a pouch, the pouch having an internal pressure, the sealing region including a first portion and a second portion, the second portion configured to fail at a lower internal pressure than the first portion.

2. The electrochemical device of claim 1, wherein the sealing region includes four sides, the first region including three of the four sides, the second region including at least a portion of one of the four sides.

3. The electrochemical device of claim 2, wherein the second region includes a full length of one of the four sides.

4. The electrochemical device of claim 2, further comprising:
an anode tab coupled to the anode current collector and extending outside the pouch; and
a cathode tab coupled to the cathode current collector and extending outside the pouch,
wherein at least one of the anode tab or the cathode tab includes a first segment and a second segment bonded together via a bonding compound, the bonding compound configured to fail at a lower pressure than the first region to cause the first segment to separate from the second segment.

5. The electrochemical device of claim 1, wherein:
the first region is formed by sealing the first film to the second film for a first time period at a first temperature and a first pressure;
the second region is formed by sealing the first film to the second film for a second time period at a second temperature and a second pressure; and
at least one of the following conditions is true:
the second time period is less than the first time period;
the second temperature is less than the first temperature; or
the second pressure is less than the first pressure.

6. The electrochemical device of claim 1, further comprising:
an anode tab coupled to the anode current collector and extending outside the pouch; and
a cathode tab coupled to the cathode current collector and extending outside the pouch,
wherein at least one of the anode tab or the cathode tab includes a first segment and a second segment bonded together via a bonding compound disposed around three outside edges of the first segment and the second segment, with a fourth outside edge of the first segment and the second segment being unbonded, such that a region between the first segment and the second segment is fluidically coupled to an inside surface of the pouch,
and wherein at least one of the first segment or the second segment includes a vent configured to open at a failure pressure.

7. The electrochemical device of claim 1, further comprising:
a frame disposed around an outside edge of the pouch, the frame including a first frame region and a second frame region, the first frame region configured to inhibit the first film and the second film from separating in the first sealing region, the second frame region configured to allow the first film and the second film to separate uninhibited in the second sealing region.

8. The electrochemical device of claim 7, wherein the second frame region is configured to allow unsealed portions of the first film and the second film to form a larger angle with the sealing region than the first frame region.

9. The electrochemical device of claim 1, wherein the anode is a first anode, the anode current collector is a first anode current collector, the cathode is a first cathode, the cathode current collector is a first cathode current collector, and the separator is a first separator, the electrochemical device further comprising:
a second anode disposed on a second anode current collector;
a second cathode disposed on a second cathode current collector; and
a second separator disposed between the anode and the cathode,
wherein the second anode, the second anode current collector, the second cathode, the second current collector, and the second current collector are disposed in the pouch.

10. The electrochemical device of claim 9, wherein the first anode current collector is coupled to the first film and the second anode current collector is coupled to the second film.

11. The electrochemical device of claim 1, wherein the anode, the anode current collector, the cathode, the cathode current collector, and the separator are wound into a spiral shape to form a cylindrical electrochemical cell.

12. An electrochemical device, comprising:
an anode disposed on an anode current collector;
a cathode disposed on a cathode current collector;
a separator disposed between the anode and the cathode;
a first film disposed on the anode current collector and having outer edges extending beyond outer edges of the anode current collector;
a second film disposed on the cathode current collector and having outer edges extending beyond outer edges of the cathode current collector, the second film bonded to the first film along a sealing region to form a pouch; and
a piercing implement disposed at a location, such that the piercing implement pierces the pouch when a pressure inside the pouch exceeds a threshold value.

13. The electrochemical device of claim 12, wherein the piercing element includes a clip with piercing teeth, the clip disposed outside of the pouch along the sealing region and configured to puncture the pouch when the pouch expands to a threshold size.

14. The electrochemical device of claim 12, wherein the piercing element includes a pressure actuated button including a prong, the pressure actuated button disposed inside the pouch and bonded to an inner wall of the pouch to form a sealed volume fluidically isolated from an inner volume of the pouch, the prong configured to pierce through the inner wall of the pouch when a pressure inside the pouch exceeds a threshold value.

15. The electrochemical device of claim 12, wherein the piercing element includes a geometry actuated button including a prong, the geometry actuated button disposed inside or outside of the pouch and bonded to an inner wall of the pouch, the geometry actuated button configured to curve upon bending of walls of the pouch due to inflation of the pouch, the curving of the geometry actuated button configured to press the prong into the inner wall of the pouch and puncture the pouch.

16. The electrochemical device of claim 12, wherein the piercing element includes a frame disposed around an outside edge of the pouch, the frame including a pin configured to pierce the pouch upon inflation and expansion of the pouch beyond a threshold volume.

17. The electrochemical device of claim 16, wherein the pin includes a metal pin installed in the frame as a separate piece.

18. The electrochemical device of claim 16, wherein the pin is part of the same piece of material as the frame.

19. The electrochemical device of claim 12, wherein the anode, the anode current collector, the cathode, the cathode current collector, and the separator are wound into a spiral shape to form a cylindrical electrochemical cell.

20. A method, comprising:
disposing an anode material onto an anode current collector;
disposing a cathode material onto a cathode current collector;
coupling the anode material to the cathode material with a separator material interposed between the anode material and the cathode material;
coupling a first film to the anode current collector;
coupling a second film to the cathode current collector;
sealing an edge between the first film and the second film to form a pouch; and
disposing a frame around the pouch to form an electrochemical cell, the frame including a puncture member configured to pierce the pouch in response to the pouch expanding to a larger than a threshold size.

21. The method of claim 20, further comprising:
operating the electrochemical cell such that the pouch inflates to larger than the threshold size; and
puncturing the pouch via the puncture member.

22. The method of claim 20, wherein the frame includes a base section and the puncture member includes a metal pin installed in the base section.

23. The method of claim 20, wherein the frame includes a base section and the puncture member is part of the same piece of material as the base section.
